(19) United States
(12) Patent Application Publication
(10) Pub. No.: US 2020/0178358 A1
(43) Pub. Date: Jun. 4, 2020

(54) MICROWAVE HEATING APPARATUS

(71) Applicant: Wayv Technologies Limited, Ware (GB)

(72) Inventors: Paul Anthony Atherton, Bagshot (GB); Philip John Stevens, Little Canfield (GB)

(21) Appl. No.: 16/725,219

(22) Filed: Dec. 23, 2019

Related U.S. Application Data
(63) Continuation of application No. 14/778,329, filed on Sep. 18, 2015, now abandoned.

(30) Foreign Application Priority Data
Mar. 18, 2013 (GB) GB1304910.1

(51) Int. Cl. H05B 6/64; H05B 6/72; H05B 6/66; H05B 6/68; H05B 6/70

(52) U.S. Cl. CPC H05B 6/6467; H05B 6/72; H05B 6/6402; H05B 6/664; Y02B 40/143; H05B 6/70; H05B 6/6426; H05B 6/6464; H05B 6/725; H05B 6/686

(57) ABSTRACT

A microwave heating apparatus comprises: a housing, arranged to define a cavity; a semiconductor RF generator, configured to provide at least one RF signal; and a plurality of RF antennas, arranged in a distributed way within the cavity and configured to radiate the at least one RF signal from the semiconductor RF generator, such that items received in the cavity are dielectrically heated by the radiation.

### RELATED APPLICATIONS

This application is a continuation of U.S. patent application Ser. No. 14/778,329, filed on Sep. 18, 2015, which is a 35 USC 371 national phase filing of International Application No. PCT/GB2014/050845, filed Mar. 18, 2014, which claims priority to U.K. patent application number GB1304910.1, filed Mar. 18, 2013, the disclosures of which are hereby incorporated herein by reference in their entireties.

### TECHNICAL FIELD OF THE INVENTION

The present invention concerns an apparatus and method for microwave heating.

### BACKGROUND TO THE INVENTION

Existing portable heating apparatus, primarily used for cooking or warming food and drink, can have difficulties in terms of efficiency and safety. For example, portable burning devices based on combustion of a fuel are inexpensive and simple to use but require good ventilation to avoid generation of toxic gases. Also, combustion-based devices can have difficulties in particular environments, particularly those where a flame is problematic, such as military or other dangerous situations.

Electrical heating devices can avoid some of the latter problems but are often inefficient. It is difficult to provide a portable power supply that represents a balance between portability and usability. The larger the portable supply (such as a battery), the heavier and less portable the device becomes. Contrastingly, smaller batteries may mean that the heating device takes a long time to reach a desired temperature or cannot be operated for very long.

Electrical heating devices can include those based on resistive heating and those which use RF to create dielectric heating, known as microwave ovens. Conventional microwave oven technology uses a magnetron as both an RF generator and amplifier. This requires a very high DC voltage and, consequently, a large power supply. CN-102679417 discusses a microwave oven that uses a semiconductor RF generator. This reduces the size of the oven, but not necessarily its power requirements. Microwave ovens are typically designed for domestic use and portability of a microwave oven is generally considered very difficult to achieve.

### SUMMARY OF THE INVENTION

Against this background, the present invention provides a microwave heating apparatus, comprising: a housing, arranged to define a cavity; a semiconductor RF generator, configured to provide at least one RF signal; and a plurality of RF antennas, arranged in a distributed way within the cavity and configured to radiate the at least one RF signal from the semiconductor RF generator, such that items received in the cavity are dielectrically heated by the radiation.

The combination of a semiconductor RF generator with a plurality of RF antennas distributed within the cavity provides high efficiency of operation within a small volume. This means that the power consumption of the RF generator and antennas is significantly lower than conventional microwave technology. Moreover, the size and mass of these components is much smaller than existing devices, providing an apparatus that is more portable and efficient enough to be used in a non-domestic setting. This can include outdoor activities, such as camping, heating food and drink for immediate consumption, such as warming babies' milk bottles and military use (where sparks or exposed flames may be hazardous for numerous reasons). For instance, the semiconductor RF generator and RF antennas may be similar to those used in wireless communications technology, such as Wireless LAN that operates at similar frequencies to those used in microwave oven technology. This technology may be used for heating of items such as food or drink, for heating liquids such as water in a boiler, for heating fuel pipes or for other applications such as autoclaving. Consequently, although the invention may provide an apparatus similar to a microwave oven, a wide range of devices may be provided using this technology not only limited to an oven-like apparatus.

The cavity may be understood as the volume within which RF radiation from the plurality of RF antennas is confined. Thus, parts of the housing may lie within the cavity in some embodiments. Preferably, the plurality of RF antennas are arranged at the edges of the cavity. Thus, they may be positioned to direct the radiation inwardly, in order to effect dielectric heating of items placed in the cavity. Alternatively, the plurality of RF antennas may be positioned at the centre of the cavity. Thus, they may be positioned to direct the radiation outwardly, in order to effect dielectric heating of items placed in the surrounding cavity. For example, this may result in a toroidal-shaped cavity or similar. Optionally, the plurality of RF antennas are arranged in at least two rows within the cavity. By distributing the antennas over multiple rows, a more efficient heating of the cavity may result. Preferably, the RF antennas are distributed with a substantially uniform spacing between them, to effect a uniform radiation pattern within the cavity.

Preferably, the plurality of RF antennas comprise at least three RF antennas. Conventional microwave ovens typically radiate RF using only one antenna. Using three RF antennas can allow a generally uniform radiation pattern across the cavity in a more efficient way and without using excessive volume. Additionally or alternatively, phasing of the radiated signals from each RF antenna may be possible. A particularly advantageous example of this is discussed below.

In the preferred embodiment, the housing comprises: a base portion; and a cover portion, configured to cooperate with the base portion so as to define the cavity. Separating the heating apparatus into two parts can provide a large number of different advantages. In particular, the cover portion and the base portion may be configured to be separable, so as to provide access to the cavity. This may avoid the need for an additional door to be provided to access the cavity.

Advantageously, the cover portion comprises an outer wall and an inner wall, defining a gap therebetween. Preferably, the inner wall of the cover portion at least partially defines a receptacle for receiving items to be heated within the cavity. Beneficially, the outer wall may at least partially define the cavity.

Beneficially, the plurality of RF antennas are arranged in the gap between the outer wall and the inner wall. Additionally, the outer wall of the cover portion may comprise shielding for confining the at least one signal radiated by the plurality of RF antennas and at least partially defining the cavity thereby. This may be an efficient structure to create a cavity for microwave heating. Additionally or alternatively, the microwave heating apparatus may further comprise a conductive component in the cover portion. Preferably, the conductive component causes heat generated by the radiation of the at least one RF signal to conduct through the inner wall of the cover portion. The conductive component may comprise one or more of: a heat spreader; a conductive material forming at least part of the inner wall; and a conductive coating on the inner wall. For example, a coating of a particular material and optionally of a particular colour (such as black) may assist in transfer of heat through the inner wall of the cover portion. Moreover, the inner wall of the cover portion may be configured to retain some heat and thereby provide a further heating effect for items placed within the cavity.

In some embodiments, the base portion cooperates with the inner wall of the cover portion to define the receptacle. Then, the base portion may further comprise: a mass measurement device, configured to determine a mass for one or more items located in the receptacle. This mass measurement device may provide a signal indicative of the mass of items placed in the receptacle. This signal may be used for control purposes, for example to control the semiconductor RF generator. One way to do this may be to prevent activation of the semiconductor RF generator or radiation of the at least one RF signal when no items are placed in the receptacle, as determined by the mass measurement device. Additionally or alternatively, the power of the at least one RF signal, its duration or modulation may be adjusted based on the output of the mass measurement device.

Preferably, the base portion further comprises shielding configured to cooperate with the shielding of the outer wall of the cover portion. In that case, the shielding of the base portion and the cover portion may thereby define the cavity. Moreover, the inner wall of the cover portion may cooperate with the base portion to define the receptacle.

In the preferred embodiment, the base portion comprises a power interface, configured to receive a power supply. The power interface may be further configured to provide electrical power from the power supply to the semiconductor RF generator. The power supply beneficially comprises one or more of: a battery; a connection to a mains power supply; and a solar panel. For example, the connection to a mains power supply may comprise a socket for receiving a power input from a mains power supply. A battery is advantageously a rechargeable battery. A battery may be recharged by a connection to a mains power supply, by a solar panel or both. Beneficially, the microwave heating apparatus further comprises a battery unit configured for cooperation with the housing, such that a surface of the battery unit faces externally from the housing when the battery unit cooperates with the housing, a solar panel being provided on the externally-facing surface. Thus, the battery unit can provide both a battery supply and a solar panel supply. Moreover, a connection to a mains power supply may also be provided within the battery unit. This may facilitate recharging of the battery within the battery unit, direct connection from the mains power supply to the microwave heating apparatus or both. Advantageously, the battery unit forms part of the base portion. Alternatively, the battery unit may be separable from the base portion.

Preferably, the microwave heating apparatus further comprises a sensor configured to detect whether the cover portion and base portion are separated. The sensor is advantageously further configured to prevent radiation of the at least one RF signal when separation is detected. In the preferred embodiment, the user interface is located on an external surface of the cover portion. The user interface may comprise one or more of: a user input device (such as buttons, switches and dials); and a user output device (such as a display or audio output). The user interface may allow the user to select one or more of: the time duration of radiation; and the average radiation power.

The semiconductor RF generator is preferably configured such that the at least one RF signal has a predetermined frequency range. Then, the housing may be configured to avoid the cavity having a dimension that affects the resonance with respect to the predetermined frequency range. For example, such a dimension may be a harmonic or sub-harmonic of the wavelength corresponding with a frequency in the predetermined frequency range.

In some embodiments, the microwave heating apparatus further comprises control logic, arranged within the housing and configured to control the semiconductor RF generator. The control logic is advantageously located in the cover portion of the housing, thereby co-locating all of the operational parts of the device, except for the power supply.

The coupling between the RF signal generator and the plurality of RF antennas may be done in a number of different ways. In some embodiments, the microwave heating apparatus further comprises at least one signal splitter that is configured to provide the at least one RF signal to more than one of the plurality of RF antennas. In this way, one RF signal may be provided to more than one RF antenna. Optionally, the semiconductor RF generator is configured to provide a plurality of RF signals. This may have a number of advantages. In one such embodiment, the plurality of RF signals may all be substantially identical. In other embodiments, the plurality of RF signals may differ from one another. Either way, at least one of the plurality of RF antennas may be configured to radiate a different one of the plurality of RF signals from at least one other of the plurality of RF antennas. In one particular embodiment, each of the plurality of RF antennas is configured to radiate a different one of the plurality of RF signals.

By making the plurality of RF signals differ in some characteristic, further effects may be provided. For example, a semiconductor RF generator may be configured to generate the plurality of RF signals with a phased relationship. This may be done such that radiation of the plurality of RF signals by the plurality of RF antennas causes dielectric heating of items received in the cavity to create a stirring effect. The distributed location of the plurality of RF antennas may further enhance this effect. Optionally, the semiconductor RF generator may be configured to generate the plurality of RF signals with the phased relationship by selectively activating and deactivating the plurality of RF signals. This intermittent operation can effect a phased relationship between the plurality of RF signals.

In some embodiments, the RF signal generator may comprise a plurality of RF amplifiers. Each of the plurality of RF amplifiers may be coupled to a respective one of the plurality of RF antennas. This may provide the at least one RF signal to the plurality of RF antennas accordingly.

Each of the plurality of RF antennas may be mounted on a printed circuit board. In the preferred embodiment, the plurality of RF antennas are mounted on one or more flexible printed circuit boards. A rigid printed circuit board may limit the possible shape of the housing. In contrast, a flexible printed circuit board may allow a wider range of shapes for the housing. In the preferred embodiment, the housing has a generally cylindrical shape. Other shapes comprising a shape with curvature may be possible.

In some embodiments, at least part of the cavity is filled with a heat-retaining gel. Alternatively, at least part of the cavity is filled with another type of heat-retaining substance. Optionally, the whole of the cavity may be heated by this substance. This heat-retaining substance or material may be heated by the radiation from the plurality of RF antennas. This may be used, in situ, to warm another item either internal or external to the cavity.

In another aspect, there is provided a method of microwave heating, comprising: generating at least one RF signal using a semiconductor RF generator; and radiating at least one RF signal from a plurality of RF antennas, arranged in a distributed way within a cavity defined by a housing, such that items received in the cavity are dielectrically heated by the radiation.

It will be understood that this method may comprise optional method steps corresponding with any one or more of the apparatus features defined herein. A combination of any of the apparatus features described herein, the method features described herein or both is also provided, even if not explicitly disclosed.

### BRIEF DESCRIPTION OF THE DRAWINGS

The invention may be put into practice in various ways, one of which will now be described by way of example only and with reference to the accompanying drawings in which:

FIG. 1 shows a schematic diagram of a microwave heating apparatus in accordance with the present invention;

FIG. 2 shows an exploded view of a microwave heating apparatus in accordance with FIG. 1;

FIG. 3 shows a cross section of a central portion of the microwave heating apparatus of FIG. 2; and

FIG. 4 depicts a printed circuit board for use with the microwave heating apparatus in accordance with FIGS. 2 and 3 in schematic form.

### DETAILED DESCRIPTION OF A PREFERRED EMBODIMENT

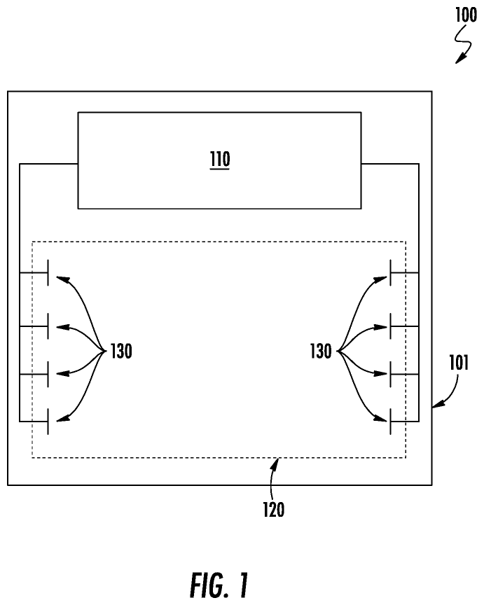

Referring first to FIG. 1, there is shown an exploded view of a microwave heating apparatus in accordance with the present invention. The microwave heating apparatus 100 comprises: a housing 101; a cavity 120 within the housing; a semiconductor RF generator 110; and a plurality of RF antennas 130. The plurality of RF antennas 130 are located within the cavity 120. The plurality of RF antennas 130 are coupled to the semiconductor RF generator 110 in order to receive at least one RF signal generated at the semiconductor RF generator.

In some embodiments, the semiconductor RF generator 110 may comprise a plurality of semiconductor RF generators, each of which is coupled to one or more of the plurality of RF antennas 130. Alternatively, a plurality of semiconductor RF amplifiers may be provided, each of which may be coupled to one or more of the plurality of RF antennas 130.

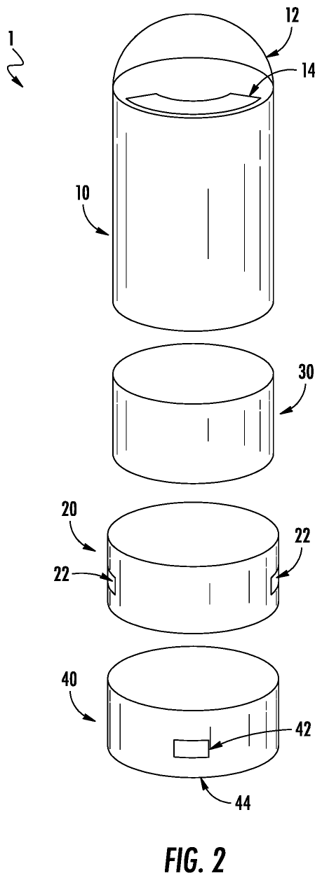

Referring next to FIG. 2, there is shown an exploded view of a microwave heating apparatus in accordance with FIG. 1. The microwave heating apparatus 1 comprises: a cover portion 10; and a base portion 20. Also, provided are a container vessel 30 and a battery unit 40.

The cover portion 10 comprises a handle 12 and a user interface 14. The handle 12 may be used for lifting the cover portion 10 when it is unlocked or the entire microwave heating apparatus 1.

The base portion 20 is configured to cooperate with the cover portion 10 in order to provide a cavity within the integrated unit. Shielding or screening (not shown) is provided in both the cover portion 10 and the base portion 20 to create a Faraday cage to confine radiation generated within the unit 1 and create the cavity. To achieve this, a locking mechanism 22 may be provided to ensure that the cover portion 10 and base portion 20 mate securely. Sensors are provided as part of the locking mechanism 22 in order to detect that the cover portion 10 and base portion 20 are correctly mated. The vessel 30 may be placed within the base portion 20 before the cover portion 10 is coupled to the base portion 20. Items, such as food or drink, placed within the vessel 30 are then placed in the correct part of the unit for heating.

The base portion 20 is configured to receive the battery unit 40. The battery unit 40 comprises a battery (not shown) within the unit. It further comprises a socket 42 for receiving a mains power supply and a solar panel 44 on the underside of the battery unit 40. The socket 42 is a USB-type socket. The solar panel 44 is coupled to the battery within the battery unit 40, such that the battery unit 40 may be separated from the base portion 20 and the solar panel 44 positioned so as to receive sunlight and recharge the battery thereby. Additionally or alternatively, the battery may be recharged using power received via the socket 42. The socket 42 may be used to receive power for supplying to the unit 1 (via the battery) directly as well.

Specific components of the microwave heating unit 1 will now be discussed in more detail. Battery technology allows the device to operate portably. The minimum required energy capacity for 1 heating cycle of the large food size, (at 50% energy efficiency) may be around 150 kJ. A NiMH battery volume of approximately 0.16 L or the equivalent of about 3 D size cells may therefore be desirable.

The power requirement for heating the large food in the specified time may be in the region of 500 W from the battery. This may require a battery volume of approximately 0.3 L using high power density cells. Using premium, high power batteries, this is about the volume that would store the energy for two heating cycles or 6 to 7 D cells. More cost effective (lower power density) cells might double this.

NiMH technology is of a lower cost and Lithium ion has a greater energy density. The latter would appear to offer a better choice as the battery size is dictated by the power requirement (as opposed to energy storage) and is of a lower cost.

A switch mode circuit for converting the battery voltage to the optimum voltage for the microwave power amplifiers is feasible but converting a total power of 500 W would be both expensive and bulky. Ideally the battery voltage would be matched to the optimum supply voltage for the microwave power amplifiers. Up to 28V may be desirable to supply the semiconductor RF generator, so a battery of up to 24 NiMH cells may be ideal. Custom made battery packs made from banks of standard cells interconnected by straps welded to the terminals and held together with heat shrink sleeving may be used.

A compromise between battery size or power and between a number of other factors may be desirable. These other factors may comprise: the target size of the product (in particular the electronics bay); cooking times; and changing functionality from cooking or reheating to warming.

The semiconductor RF generator and the plurality of RF antennas are desirably provided in an efficient way. Legislation may demand that the microwave oven uses an unlicensed Industrial, Scientific, Medical (ISM) frequency band at around 2.45 GHz. Techniques that are used to synthesise these frequencies from a low frequency crystal may be implemented.

The semiconductor RF generator may be a single high power device whose output power is divided between the plurality of RF antennas that are then distributed around the cavity. Printed circuit power splitters can be used in single frequency circuits like this one.

Although there are techniques for meandering the transmission lines, the printed Y pattern might be over 30 mm long and a tree of them may be needed to distribute the power to a number of antennas, which may also be printed on the PCB. One drawback of this approach may that the even sharing of the power between the arms relies upon each arm (and hence each antenna) seeing the impedance assumed in the design. The impedance seen by each antenna may vary with the proximity, and the moisture content of the food that it is directed towards.

The power gain required from the amplifier may be the oven microwave power divided by the power from the frequency source. This may demand a multistage amplifier (using multiple transistors) but the first stage (or stages) could use lower power devices.

Contrastingly, multiple microwave amplifiers may be used to distribute the signal from the frequency source to the amplifiers. The amplifiers may have relatively predictable impedances so the frequency signal may be distributed to them using the lossless power splitters described above. However, as the signal level will be much smaller than the amplified power delivered to the oven, a lossy power splitting technique could be used without impacting the overall efficiency. It is possible that a single amplifier device (such as a transistor) will have enough gain. A multistage design could be used for the amplifiers that directly drive the antennae. Alternatively amplifiers could be distributed between the splitters.

The RF generator may be based on LDMOS technology, such as has been developed for the communications industry. Multiple devices are used to generate more than one RF signal. Three or more devices appear to have a beneficial effect, as will be explained below. Such devices are generally guaranteed to cope with an output Voltage Standing Wave Ratio (VSWR) of up to 10:1. Running the high power devices at less than their maximum power may give greater robustness though. For example, a 140 W device delivering 100 W may result in a more robust design, but may reduce efficiency to around 35%. A simple technique for detecting a high VSWR from the amplitude of the RF at the transistor output may be possible.

Running the RF power devices at their maximum power may give up to 55% efficiency or more, but they may be more robust when operated at 30 to 36% efficiency. Such devices could be driven almost directly from the battery unit and from a reasonably high voltage (up to 28V), which need not require a switch mode power supply to be provided (with its associated inefficiencies).

Overall efficiency may be dependent upon the quality of the components, orientation of the antennas, tightness and proximity of the coupling arrangement. This may result in reduced lossiness, which combined with convection heat, may increase the overall efficiency (in comparison to conventional microwave heating devices) towards 70% to 90%. The close proximity of the items to be heated to the source of RF radiation (the RF antennas) may be a factor in such efficiency gains.

The maximum junction temperature of the silicon may be around 225 C. This may make it more feasible to use some of the waste heat to raise the temperature of an inner wall of the cover portion 10 to the target temperature of the oven. Alternatively, an even slightly higher temperature may be possible, making it feasible to use this “waste” heat to warm the food. Thus, even if 50% efficiency for the RF power is not achieved, this may be compensated by use of more conducted heat from the device itself (for example, because a higher oven wall temperature may increase the rate of conduction or convection).

Design of the PCB upon which the semiconductor RF generator is located is a significant part of the design. For example, a rigid PCB in an electronics bay could be connected to wire aerials in the oven walls. This has the following advantages: room for taller power switching components on the same PCB; and low loss microwave PCB materials that could both handle high powers (good breakdown) and have low loss at these frequencies. However, it is also unattractive for a number of reasons: the shorter the transmission lines from the power sources to the antennae, the lower the loss in the line and hence the less critical the quality of the lines dielectric loss; the shorter the transmission lines from the power sources to the antennae, the less critical the impedance of the line; bonding wire antennas to the oven skin may not be a low cost volume operation; heat from the microwave power sources may not be coupled to the oven walls; and the oven may need to be screened and the screening wall should be an integral part of its design, otherwise it will disturb its impedance and effectiveness, such that the distance from the antennas to the screening case may need to be controlled.

Distributing a number of small PCBs arranged around the cavity may assist. However, such a design may require the distribution of the RF to the final amplifiers through board to board connectors which is feasible, but may lead to some performance problems and make the screening more challenging.

The use of a flexible PCB may open up many opportunities and has some distinct advantages: the antennae can be printed onto the PCB as copper shapes; a double sided flexible PCB can be a microstrip design with tracks on the inside and a ground plane on the outside, giving some inherent screening of the side wall without cost if wrapped around the inside wall of the oven; the power devices can be soldered directly to the flexible PCB close to the antennas, reducing lossiness, and increasing efficiency; and the power devices could be distributed around the unit and be thermally coupled to the wall.

Power handling and loss are further considerations in the PCB design. The maximum power limit a transmission line can handle may be determined by either the combination of maximum temperature rating and self heating, or the maximum voltage on the line and the dielectric strength. Dielectric strengths for all of these sorts of materials are over 500 Volts per mil (that is 500 Volts per 0.0254 mm) so dielectric strength may not be a limitation. There may be two main reasons for power loss and heating in printed transmission lines and components: copper lossiness; and dielectric lossiness. Copper lossiness may be reduced by wider tracks, which may mean thicker PCB dielectrics, lower dielectric constant or both for the same impedance. At these frequencies the dielectric loss becomes greater than the copper lossiness for FR4 (glass-reinforced epoxy laminate), while they are still less for the lowest loss microwave dielectrics such as loaded Teflon.

In view of the above, flexible PCBs would be considered to be a good option, but there are some challenges to be considered. These may include the following. Flexible PCBs tend to have thin dielectrics leading to thinner transmission lines, greater loss and more self heating of the PCB. However, this may be mitigated by the fact that polyimide dielectrics benefit from a lower dielectric constant (thicker tracks) and lower loss. A crosshatched or perforated ground plane could be considered in areas where impedance control is not critical as this reduces the capacitance per unit area and increases the transmission line width.

Soft PCB substrates such as glass loaded PTFE are typically thicker than a true “flexible PCB”, but may be bent to the curvature of the oven cavity wall. These are therefore included in the term “flexible PCB” as used herein. Being thicker and with a low dielectric constant they may give good copper widths for transmission lines and antennas.

The high temperature rating, medium dielectric constant and medium loss makes standard polyimide flexible PCBs appear to be a good candidate. The thickest dielectric may increase the copper transmission line widths and reduce losses. The lengths of electrically functional copper (such as the antennas) are related to the operating wavelength. However, interconnecting transmission lines are beneficially kept as short as possible. The tracks between the power devices and the antenna should be very small. Perforated ground planes on the reverse may be used to increase copper widths on the component side in areas where impedance control are less critical. Thicker copper layers can be specified. Nickel or gold plating or flashing should only be used on the solder pads as the nickel layer causes increased loss.

The RF antennas could be distributed in both the top and bottom halves of the cavity. This may ensure more even heating of the food, which may not be the case if the antennas were distributed singularly in the bottom half or top half only. In the case of liquids (such as when warming a baby's bottle) antennas around the bottom third or two thirds of the cavity would probably be acceptable, as convection within the liquid (such as milk) would distribute the heat fairly quickly if there was more heating at the bottom of the milk. It is difficult to predict the penetration within other foodstuffs that are too viscous for convection, as the characteristics of the food are variable. The penetration of microwaves (and hence heat) may also decrease with higher moisture and salt content.

An electronic stirring effect can be achieved using three or more RF sources. Activating the majority of the antennas to keep the average power up and reduce the number and power rating of the devices is desirable. By turning a single RF antenna off, the standing wave pattern in the oven cavity will change compared to having them all on locating the nulls in different positions. Turning off each antenna in turn will even out the heating. Three is probably the minimum number of devices for this to be effective. Four distinct RF standing wave patterns may be used to eliminate cold spots, as the nulls would be in different positions.

The following four states could be cycled in turn to achieve this effect: all on; first off; second off; third off. Alternatively, the ‘all on’ state could be reverted to in between each of the other three states (that is: all on; first off; all on; second off; all on; third off). Keeping the number of antennae/power drivers that are switched on to a maximum is desirable as this sort of microwave device rarely has a low power off mode and an extra device may be needed to switch the power to it. It is desirable that the antennas are not separated by exact wavelengths.

An alternative form of electronic stirring that would have less impact on the device power would be to shift the phase of the signal fed to the elements. A significant difference between this and a full size oven is that a full size oven is normally if not always predominantly full of air with a relatively small proportion of food. In the case of the embodiment of FIG. 2, it may be much easier to deliver energy to the food without standing waves as the distance between the food and the side walls is smaller than half a wavelength. If the food is close to the antenna this may disturb the impedance and matching. Pressing a finger against a transmission line or aerial almost always improves the match due to increased absorption (match is measured as how much power bounces back). This may mean that the food being within half, probably a quarter wavelength of the antennae may give more consistent matching and power transfer than a conventional oven.

The microwave heating unit 1 should be dimensioned appropriately. Dimensions close to multiples or submultiples of the wavelength of the microwave frequency could result in resonances resulting in more pronounced standing wave patterns (hot and cold spots) and dangerous high field strengths, possibly discharges or sparks if there is not enough, or no food in the oven. The stirring effect discussed above, along with the absorption of energy by the food (if present) may mitigate this.

The following dimensions may cause problems, for example: wavelength at 2.45 GHz in free space (air)=122 mm; ½ wavelength=61 mm; and ½ wavelength=30 mm. These dimensions could apply to the dimensions of anything metal, or voids in anything metal exposed to the microwaves. The only item of real significance may be the screening case within the oven which may be an outer metal foil such as the ground plane of a flexible PCB or a metal outer skin.

Food contains a high proportion of moisture whose dielectric constant is around 80 times that of air. The wavelength of 2.45 GHz microwaves in water is about 9 (square root of 80) times shorter: wavelength at 2.45 GHz in water=13.6 mm. This suggests that the risk of cold spots due to standing waves relates only to standing waves in the air. The hot and cold spots due to standing waves within the food may be close together and would even out quickly. The absorption of the microwave power by the food may also mean there is less energy in the reflected wave so standing waves would be less deep (the cold nulls would not be as cold).

Insulation of the cavity is also desirable. If the power devices are about 50% efficient, they will generate as much heat as is delivered to the food. It is desirable that the casing outside these devices is of low enough conductivity that the heat generated raises the temperature of the inner skin of the oven. If this temperature reaches the target 60 C for the food then it will eliminate heat loss from the food to the oven wall. If it is higher than 60 C, some of the waste heat will be used to provide convected energy to heat the food further. In normal operation the junction temperature in the core of the power devices should not approach their maximum junction temperature. A temperature cut-out could protect them for example, when the oven is operated empty and the transistor cases get too hot. This could also protect the inner skin of the oven becoming dangerously hot.

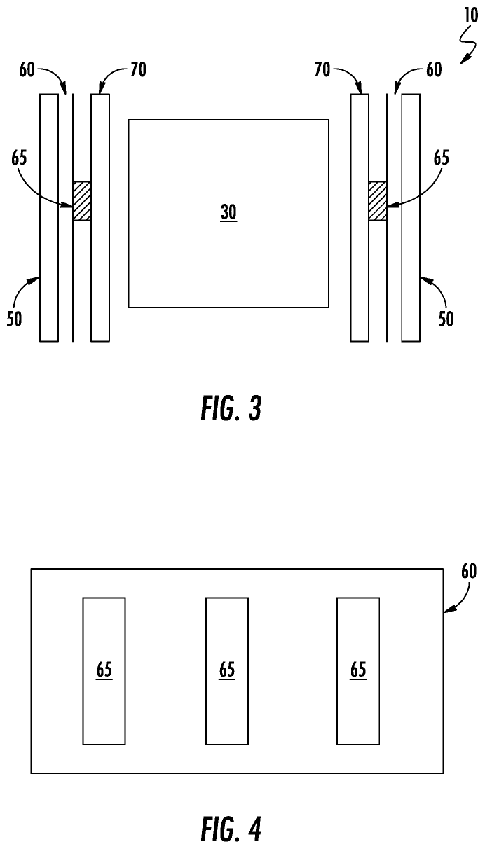

Referring next to FIG. 3, there is shown a cross section of a central portion of the microwave heating apparatus 1 of FIG. 2. The cover portion 10 comprises: an outer wall 50; a printed circuit board 60; an RF antenna module 65; and an inner wall 70. For completeness, the vessel 30 is shown located within the cover portion 10.

The outer wall 50 provides shielding and defines the cavity in which the microwave radiation is contained. The printed circuit board 60 is a flexible PCB allowing the cylindrical shape of cover portion 10 shown in FIG. 2. A plurality of RF antenna modules 65 are mounted on the printed circuit board 60 and configured to direct radiation through the inner wall 70. This radiation causes dielectric heating of items placed in the storage vessel 30. A conductive coating is provided to the inner wall 70 in order to facilitate transfer of heat within the receptacle defined by the inner wall 70.

Dimensions of the inner Wall 70 and outer wall 50 are now considered. For food in the vessel 30 to reach 60 C, the following assumptions may be made: the device side of the inner wall 70 reaches (on average) 100 C; the inner wall 70 is made of a plastic of conductivity approx 0.3 W/mK; the active wall area (Skin area) is 1600 mm² (0.0016 m²); and the wall thickness is 1 mm (0.001 m). Then, the power transferred=(area×temperature difference×conductivity)/(thickness)=(0.0016×40×0.3)/(0.001)=19 W. This suggests that the contribution from waste heat may be small. The benefit of raising the oven walls to or above the same temperature as the food may however be of greater benefit as it could effectively eliminate loss of heat from the food to the oven walls.

A similar calculation for the outer wall 50 may be more complex, as the extending design implies air gaps. The outer walls may conduct the waste power without the device junctions approaching their maximum limits.

Referring next to FIG. 4, there is shown a schematic diagram of a printed circuit board 60 in accordance with the embodiments shown in FIG. 3. A plurality of RF antenna modules 65 are mounted on the printed circuit board 60. These are distributed in order to provide a uniform radiation profile within the cavity.

RF leakage is a further consideration in the design. If RF leaks, the power density will fall off as the square of the distance from the oven (the source), so in practice the hazard to a user is worst the closer they are to the oven. Users would be advised against holding the oven in their hands while it is working. In any event, the whole of the outer (or intermediate) screening shell should be continuous with no single openings, slots or non-conductive butt joins with a dimension greater than 6 mm. Any large areas of metallic screen should either be continuous or if they are perforated the holes should be no more than 2 mm diameter and with 2 mm gaps between the holes.

The design of the sliding joint between the cover portion 10 and the base portion 20 uses a mechanical interlock switch to ensure the electronics only energise when the unit is fully closed or fully opened. To eliminate excessive leakage from the sliding joint there should be no line of sight through the joint into the oven. Instead the path of the microwaves through the butt joint should be a Z path so that there are at least two right angle changes in direction with the gaps as small as possible (paint or coating thickness). A conductive butt joint may be considered.

The power available from the solar panel 44 may be estimated as follows. The solar panel area may be no more than about 50 cm². Current solar cells have efficiencies of between 20% and 30%, but 15% efficiency can be assumed for current cost-effective mature technology in full production. According to NASA, the peak power density from the sun, “at high noon, with the sun directly overhead, (as would occur at the equator or in the tropics)” is 137 mW/cm². The peak instantaneous power output from such a solar cell is approximately 50×0.1×0.137 W=1 W. Noon sun is, of course, not sustained for 12 hours per day; the inclination of the sun would reduce this by about 50% so the total energy generated would then be approximately 1×12×60×60×0.5=21 KJ.

Assembling the panel from multiple small cells in series might reduce how effectively they use the available area. If the total solar panel voltage (usually about 0.5V per cell) exceeds the battery voltage (28V) the charging circuit could be simplified. It may be assumed that the charge to discharge efficiency of the battery combined with the charging circuit efficiency gives 60% efficiency. Then, the number of days to generate the 160 kJ required from the battery for a single heating cycle of a small food size would be about 160/(21×0.6)=12 days. This is very much a maximum idealised figure for the tropics and assumes permanently clear skies and the oven being in full sun, never in the shade.

However a NiMH battery would loose about 30% of its charge in a month: in this case about 50 J. In the tropics this would be replaced in as little as 4 days. Energy collection within a month may be this high in many parts of the world, even in moderate shade, effectively making the battery charge last indefinitely if not used.

Although a specific embodiment of the invention has now been described, the skilled person will understand that various variations and modifications are possible.

For example, a variant design of the microwave heating apparatus may be for use as a baby bottle warmer. This may be a less challenging design for the following reasons: bottle warmers start from room temperature and heat milk to much lower temperatures than other microwave oven applications might use; and both the energy and power requirements are reduced due to the lower temperature rise required. Also, the waste heat from the RF amplifiers may raise the wall temperature above the temperature of the bottle allowing some of this waste heat to be employed to warm the bottle and further reducing the power and energy requirements.

Moreover, the microwave heating technology discussed herein may be applicable to types of heating other than for heating of food and drink. For example, the technology may be used for heating water in a boiler, for central heating or other hot water requirements. For example, the array of RF antennas may be arranged inside a gel sleeve. This may reside in a water tank (similar to an immersion heater).

A further concept may use a spherical array of the RF antennas with the product to be heated (or autoclaved) suspended on a platform in the centre. This may enable a product to be subjected to 360° of exposure. An intelligent control system may be used to achieve this, for instance.

A further application may involve small-scale warming devices. For example, the technology may be used in conjunction with a heat-retaining gel (such as discussed above) to keep pipes or other items warm. This may be useful to prevent freezing of fuel pipes in a vehicle, particularly with diesel fuel. The heating requirements in this case may be significantly less than for food and drink and the advantage that no exposed flame is needed may be of benefit.

The shape of the housing, cavity or both need not be cylindrical. A wide variety of shapes are possible, including: cuboid; rectangular; spherical; and variations thereon. Cuboid and rectangular housings, for example (as this may also be applicable to other shapes of housing), may be provided with a front opening door (similar to a conventional domestic microwave oven). In this case, the antennas may be arranged on all four walls and the top. The spherical shape may be opened from the middle (with a lift-up lid action) and the product may be suspended on a platform in the middle of the sphere.

Other forms of design are also possible. For example, a variation on the design shown in FIG. 2 may comprise a top portion that flips open. Another alternative may compress from the top down into roughly half its size. Although these designs may be of a cylindrical shape, other shapes are possible as discussed above.

1. A microwave heating apparatus, comprising:
a housing comprising a base portion and a cover portion configured to cooperate with the base portion so as to define a cavity;
a semiconductor RF generator, configured to provide at least one RF signal; and
at least one RF antenna arranged within the cavity and configured to radiate the at least one RF signal from the semiconductor RF generator, such that items received in the cavity are dielectrically heated by the radiation, wherein the at least one RF antenna is arranged in a wall of the cover portion where the wall of the cover portion comprises shielding for confining the at least one RF signal radiated by the at least one RF antenna and at least partially defining the cavity thereby.

2. The microwave heating apparatus of claim 19, wherein the plurality of RF antennas are arranged at the edges of the cavity.

3. The microwave heating apparatus of claim 2, wherein the plurality of RF antennas are arranged in at least two rows within the cavity.

4. The microwave heating apparatus of claim 19, wherein the plurality of RF antennas comprise at least 3 RF antennas.

5. The microwave heating apparatus of claim 1, wherein the cover portion and the base portion are configured to be separable, so as to provide access to the cavity.

6. The microwave heating apparatus of claim 1, wherein the cover portion comprises an outer wall and an inner wall, defining a gap therebetween.

7. The microwave heating apparatus of claim 6, wherein the inner wall of the cover portion at least partially defines a receptacle for receiving items to be heated within the cavity.

8. The microwave heating apparatus of claim 7, wherein the base portion cooperates with the inner wall of the cover portion to define the receptacle, the base portion further comprising:
a mass measurement device, configured to determine a mass for one or more items located in the receptacle.

9. The microwave heating apparatus of claim 6, wherein the base portion further comprises shielding configured to cooperate with the shielding of the outer wall of the cover portion, the shielding of the base portion, and the cover portion defining the cavity.

10. The microwave heating apparatus of claim 6, further comprising a conductive component in the cover portion, the conductive component causing heat generated by radiation of the at least one RF signal to conduct through the inner wall of the cover portion.

11. The microwave heating apparatus of claim 1, wherein the base portion comprises a power interface, configured to receive a power supply and to provide electrical power from the power supply to the semiconductor RF generator.

12. The microwave heating apparatus of claim 11, wherein the power supply comprises one or more of: a battery; a connection to a mains power supply; and a solar panel.

13. The microwave heating apparatus of claim 11, further comprising:
a battery unit configured for cooperation with the housing, such that a surface of the battery unit faces externally from the housing when the battery unit cooperates with the housing, a solar panel being provided on the externally-facing surface.

14. The microwave heating apparatus of claim 13, wherein the battery unit forms part of the base portion.

15. The microwave heating apparatus of claim 1, further comprising:
a sensor configured to detect whether the cover portion and the base portion are separated and to prevent radiation of the at least one RF signal when separation is detected.

16. The microwave heating apparatus of claim 1, further comprising:
a user interface, located on an external surface of the cover portion.

17. The microwave heating apparatus of claim 1, wherein the semiconductor RF generator is configured such that the at least one RF signal has a predetermined frequency range and wherein the housing is configured to avoid the cavity having a dimension that effects a resonance with respect to the predetermined frequency range.

18. The microwave heating apparatus of claim 1, further comprising:
control logic, arranged within the housing and configured to control the semiconductor RF generator.

19. The microwave heating apparatus of claim 1, further comprising a plurality of RF antennas.

20. The microwave heating apparatus of claim 19, wherein the semiconductor RF generator is configured to provide a plurality of RF signals.
